(19) United States
(12) Patent Application Publication
(10) Pub. No.: US 2025/0326508 A1
(43) Pub. Date: Oct. 23, 2025

(54) TURNING UNIT AND METHOD FOR TURNING AN OPEN CONTAINER CONTAINING FLAT PRODUCTS, AND SYSTEM AND METHOD FOR THE PORTIONED FILLING OF FLAT PRODUCTS

(71) Applicant: Hastamat Verpackungstechnik GmbH + Co. KG, Lahnau (DE)

(72) Inventors: Marco Hinter, Breitscheid (DE); Viktor Wagner, Lollar (DE)

(21) Appl. No.: 18/863,499

(22) PCT Filed: Apr. 5, 2023
(86) PCT No.: PCT/EP2023/058960

§ 371 Date: Nov. 6, 2024

(30) Foreign Application Priority Data
May 6, 2022 (DE) 10 2022 111 365.5

(51) Int. Cl. B65B 5/06; B65G 47/248

(52) U.S. Cl. CPC B65B 5/064; B65G 47/248

(57) ABSTRACT

The invention relates to a turning unit for turning a, preferably dish-shaped, open container (19) with a portion of flat products, in particular of potato chips or the like, received in the container, the turning unit comprising at least one turning device (15) which is set up to turn the container by transferring it from a first orientation of the container, in which an opening (20) of the container is oriented in a first direction, to a second orientation, in which the opening is oriented in a second direction, by rotating the container about an axis of the container.

The invention relates to a turning unit and a method for turning a, preferably bowl-shaped, open container with a portion of flat products, in particular of potato chips or the like, received in the container. Further, the present invention relates to a system and a method for portioned filling of flat products, in particular of potato chips or the like.

Various methods for portioned filling of flat products, such as potato chips or the like, are well known from the prior art.

In a method known from the prior art, the flat products are provided in portions in the form of horizontal stacks, wherein these horizontal stacks are then automatically packaged in can-shaped containers, which form a package. Depending on the type of flat products, however, this type of packaging is not always practical or desirable and, in addition, is comparatively cost-intensive.

Further, a method is known from the prior art, in which horizontal stacks of flat products are first transferred into bowl-shaped containers, which are regularly formed from a plastic, and the bowl-shaped containers with the stacks received in the bowl-shaped containers are subsequently packaged in a package. Covering the horizontal stacks with the bowl-shaped containers from above, with an opening of the bowl-shaped containers positioned vertically downwards, in order to transfer the horizontal stacks into the bowl-shaped containers, is known in particular. Afterwards, the bowl-shaped containers with the stacks received in the bowl-shaped containers are packaged in a package. This packaging is regularly a tube bag. In this case, however, the process can only be partially automated, because at least the packaging of the bowl-shaped containers with the stacks received in the bowl-shaped containers in tube bags themselves and/or turning of the bowl-shaped containers with the stacks received in the bowl-shaped containers by 180°, whereby subsequent automatic packaging of the bowl-shaped containers with the stacks received in the bowl-shaped containers in tube bags by means of a tube bagging machine becomes possible in the first place, must be carried out manually or by hand.

In particular, the fact that the presence of a process step carried out manually or by hand is associated with a comparatively large expenditure of time and money, is therefore a disadvantage of the latter type of portioned filling of flat products.

The present invention is therefore based on the problem of proposing a turning unit and a method for turning a, preferably bowl-shaped, open container with a portion of flat products, in particular of potato chips or the like, received in the container, as well as a system and a method for portioned filling of flat products, in particular of potato chips or the like, which system or method simplifies portioned filling of flat products, in particular of potato chips or the like, in which a, preferably bowl-shaped, open container with a portion of flat products, in particular of potato chips or the like, received in the container is packaged in a tube bag.

This problem is solved by a turning unit and a method for turning a, preferably bowl-shaped, open container with a portion of flat products, in particular of potato chips or the like, received in the container, with the features of claims 1 and 20, as well as a system and method for portioned filling of flat products, in particular of potato chips or the like, with the features of claims 18 and 21.

The turning unit according to the invention for turning a, preferably bowl-shaped, open container with a portion of flat products, in particular of potato chips or the like, received in the container, comprises at least one turning device, which is set up to turn the container by transferring it from a first orientation of the container, in which an opening of the container is oriented in a first direction, to a second orientation of the container, in which the opening is oriented in a second direction, by a rotation of the container about an axis of the container.

The turning unit according to the invention allows automatic turning of an open container from a first orientation of the container, in which an opening or a bottom of the container is oriented in a first direction, to a second orientation of the container, in which the opening or the bottom is oriented in a second direction, the first direction being different from the second direction. In particular, the turning unit according to the invention thus also makes it possible to turn an open container with an opening positioned vertically downwards and covering a portion of flat products from above by transferring it from this first orientation to a second orientation in such a way that the open container with the flat products received in the container may be subsequently packaged after turning, in particular in a tube bag, by means of a packaging unit or horizontal packing machine or tube bagging machine. Using the turning unit according to the invention, portioned filling of flat products, in which an open container with a portion of flat products received in the container is packaged in a tube bag forming a package, is therefore significantly simplified, as manual intervention or intervention by hand is no longer required. In particular, an expenditure of time and money can thus be considerably reduced

Advantageously, the rotation may only take place about one axis of the container, for example about a longitudinal axis of the container. Having the container rotated multiple times about different axes of the container may nevertheless be provided. If the container is conveyed to the turning unit in a conveying direction, the rotation may preferably take place about an axis of the container running parallel to the conveying direction.

The container is an open container and thus has no lid or closure, particularly during turning or the turning process. In principle, however, the turning unit may also be suitable for turning a closed container. Preferably, the open container is bowl-shaped or dish-shaped and is thus formed as a bowl or dish, the term “bowl” being understood as a receiving bowl or portioning bowl in the present case. Advantageously, the container may be formed from a rigid material. The material may be a plastic material, for example. Further, a geometry of the container may be adapted to the shape of the flat products. When the container is viewed in section along a plane running parallel to a bottom of the container, the container may in particular have a circular, square or rectangular cross-sectional shape. The container may have a bottom and one or more side walls. The side wall or side walls may have an edge, which may delimit the opening. The opening or the edge may preferably extend in a plane parallel to the floor. In this case, for example, the bottom is then oriented vertically downwards in one direction in an orientation of the container, in which the opening is oriented vertically upwards in one direction. A direction of an orientation of the opening or the bottom may, for example, be de fined by a direction of a normal vector on a plane, in which the opening extends, or on a surface of the bottom.

The flat products are advantageously stackable products, so that portions of the flat products, which are to be received in the containers, may be provided or portioned in the form of, preferably horizontal, stacks. In particular, the flat products may be snack products suitable for consumption, such as potato chips, cookies, candy bars or chocolate bars or the like.

Advantageously, an angle between the first direction and the second direction may be 180°. However, other angles, such as 90°, are also conceivable.

Advantageously, the opening may be oriented vertically downwards in the first orientation, and the opening may be oriented vertically upwards and/or a bottom of the container may be oriented vertically downwards in the second orientation. This allows a container with an opening positioned vertically downwards and covering a portion of flat products to be turned by 180° from this orientation in such a way that the opening is oriented vertically upwards after turning or the bottom of the container is oriented vertically downwards. Advantageously, in this case, the opening may then extend in a plane parallel to the bottom. Depending on the design of the container, it may be provided that the opening is oriented vertically downwards in the first orientation and in such a way that that the bottom of the container is oriented vertically downwards in the second orientation, wherein the opening may also not be oriented vertically upwards in the second orientation. In this case, the opening may then thus also extend in a plane, which is not parallel to the bottom.

Advantageously, the turning device may be formed in such a way that the container can be turned while the products remain in the container. Advantageously, the products can thus be prevented from falling out of the container during turning.

In an advantageous embodiment of the invention, the turning device may have a turning mechanism, which the container may be removably connectable to, wherein the turning mechanism may be formed to be rotatable to perform the rotation of the container. The turning mechanism may then perform a rotational movement together with the container connected to the turning mechanism in order to turn the container by transferring it from the first orientation to the second orientation, wherein the turning mechanism may be rotated from a first orientation of the turning mechanism to a second orientation of the turning mechanism. The container may advantageously be removably connectable to the turning mechanism or may be such that it can be disposed at the turning mechanism. After the turning process, the container may therefore be removed from the turning mechanism. The connection between the turning mechanism and the container is preferably a form-fit or force-locked connection. The container may be conveyable to the turning device by means of a conveying mechanism of the turning device or at least a portioning device of a portioning unit of a system for portioned filling, wherein the container may be connected to the turning mechanism as a result of a conveying movement. After removal of the container from the turning mechanism, the turning mechanism may then be rotated from the second orientation to the first orientation in order to receive a further container for turning the further container or to be connected thereto.

The turning mechanism may be formed in a form of a hollow cylinder or a tube. The container may then be such that it receivable in an interior of the hollow cylinder or the tube in order to perform the rotation.

In an advantageous embodiment of the invention, the turning mechanism may have a first section, which is formed in the form of a segment of a cylinder and which may be rotatable about a longitudinal axis of the cylinder, wherein the container may be removably connectable to an inside of the first section. Advantageously, the first section may be in the form of a segment of a hollow cylinder.

In an advantageous embodiment of the invention, the turning mechanism may have a second section, which is formed in the form of a circle or a disk and which may be disposed at an axial end of the first section in a rotationally fixed manner or connected thereto in such a way that a center of the circle or the disk lies at least approximately on the longitudinal axis of the cylinder, wherein the second section may have a passage, which may be formed to guide the container through it. According to this, the first section and the second section may in particular be disposed against each other in such a way that the second section can more or less at least approximately form a bottom surface of the cylinder and the first section can form part of a lateral surface of the cylinder. The second section may be rotatably mounted in a housing mechanism of the turning device. The turning unit may comprise a housing device with a cover, in which second sections of turning mechanisms of turning devices may be mounted together, if the turning unit should comprise a plurality of turning devices. When the container is conveyed to the turning mechanism by means of the conveying mechanism, the container may be guided through the passage and get to the first section as a result of the conveying movement, in particular for removable connection of the container to the first section. The geometry of the passage may be adapted to a shape, in particular a cross-sectional shape, of the container.

Advantageously, the container may be removably connectable to the inside in such a way that the opening may be such that it can be coverable at least partially, preferably completely, by the inside by an orientation of the opening with the inside. As a result, it is possible to hold the products in the container during turning or to prevent the products from falling out of the container. A geometry of the inside may be adapted to a shape of the products or to a shape of parts of the products projecting beyond the edge, in particular if the products received in the container project beyond an edge of the container. A distance between the opening and the inside or the products and the inside may advantageously be as small as possible when the container is disposed on the inner surface, in order to minimize play of the products in the container in the direction of the opening out of the container.

Advantageously, the turning mechanism may have a receptacle which may be formed to receive the container at least in sections, in particular by at least partially encompassing an edge of a wall or side wall of the container, said edge delimiting the opening, so as to removably connect the container to the turning mechanism. In particular, the receptacle may be intended to receive or encompass an edge of two opposing side walls of the container. The container may get into the receptacle or be introduced or pushed into the receptacle as a result of the conveying movement of the conveying mechanism. In particular, the first section or the inside may have the receptacle.

In one embodiment of the invention, the receptacle may be formed as a receiving track, in which the edge may be receivable and guidable in a longitudinally movable manner. Advantageously, the receiving track may be formed in the shape of two opposing guide grooves extending in one direction of the longitudinal axis of the cylinder on the inside, in which the edge of the two opposing side walls may be receivable. The receptacle or the receiving track may extend over an entire length of the first section and beyond the axial end of the first section to an axial end of the second section, from where the container may be guided through the passageway and get to the first section while the edge is transferred into the receptacle or receiving track. Therefore, both the first section and the second section may have or form the receptacle or the receiving track. At another axial end of the first section opposite the axial end of the first section, the edge may leave the receptacle or receiving track after the container has been turned. It may also be provided that only the first section has or forms the receptacle or receiving track.

Advantageously, the turning device may have a drive mechanism for driving the turning mechanism. The drive mechanism may cause the turning mechanism to undergo a rotational movement. The drive mechanism may be a drive motor, in particular an electric motor.

Further, the turning device may have a transmission mechanism meshing with the drive mechanism and the turning mechanism.

In particular, the transmission mechanism may be a gear transmission, which may have a first gear wheel coupled to the drive mechanism and a second gear wheel meshing with the first gear wheel and coupled to the turning mechanism. Advantageously, the first gear wheel and the second gear wheel may be straight-toothed. The second gear wheel may be disposed at or connected to the second section. In particular, the second gear wheel may be disposed at a circumference of the circle or disk. Advantageously, the gear transmission is formed as a helical gear transmission. Preferably, a radius of the second gear wheel is larger than a radius of the first gear wheel.

Further, the turning device may have a sensor mechanism for monitoring a turning process.

Advantageously, the turning device may have a sensor mechanism, which may be set up to monitor a removal of the container from the turning mechanism after the container has been turned. The sensor mechanism may then be disposed adjacent to the turning mechanism. Preferably, the sensor mechanism may have an optoelectronic sensor, which may in particular be a light barrier with a transmitter and a receiver. For example, a laser diode may be used as a transmitter and a photodiode as a receiver. The sensor mechanism may detect a moment when the container has completely left the turning mechanism or the receptacle and transmit a signal describing the container leaving the turning mechanism or the receptacle to a control mechanism of the turning device in order to notify the control mechanism that the turning mechanism is available for a further turning process. Immediately, the control mechanism may control the drive mechanism in such a way that it rotates the turning mechanism to a position or orientation of the turning mechanism, in which the turning mechanism may receive another container in order to subsequently turn it.

Advantageously, the turning device may have a conveying mechanism for conveying away the container after turning. Preferably, the conveying mechanism is a conveyor belt. A conveying direction may run parallel to a direction of rotation of the container or to the axis of the container about which the rotation takes place.

In an advantageous embodiment of the invention, the conveying mechanism may be disposed adjacent to the turning mechanism in such a way that a bottom of the container may be transferable to mesh with a conveying means of the conveying mechanism by transferring the container to the second orientation, so that the container may be removed from the turning mechanism by a force effect of the conveying means on the bottom. The conveying mechanism may be disposed below the turning mechanism or the first section for this purpose. In particular, the container may leave the receptacle or be moved out of same by the force effect of the conveying means, for example a belt of the conveyor belt. The receptacle may be formed in such a way that it offers sufficient resistance after turning in order to ensure a frictional connection by the conveyor means or conveyor belt.

In one embodiment of the invention, the turning unit may comprise a plurality of turning devices disposed parallel and next to each other. For example, the turning unit may comprise two, three, four, five, six, seven, eight or nine turning devices disposed parallel and next to each other. Advantageously, the turning devices are formed in the same way. The turning devices may be formed as individual modules that are connectable to each other so that the turning unit may be modularly modified, in particular expanded.

Advantageously, the turning unit may then have a merging device, which is disposed downstream of the turning devices and which may be set up to merge containers turned by means of the turning devices, preferably clocked, into one lane. The merging device may have a removal mechanism, which may be formed in such a way that, in particular with regard to a width, the containers conveyed by the conveying mechanisms of the turning devices can all get on a common belt of the removal mechanism disposed downstream of the conveying mechanism. Further, the merging device may have an orientation mechanism and a clocking mechanism in order to first orient and to single and to dispense the containers getting onto the removal mechanism, such dispensing being in a clocked manner. The orientation mechanism may be formed in the shape of a lateral guide running along both sides of the container in a removal direction. After the containers have been dispensed by means of the clocking mechanism, the containers, which are still being conveyed in parallel lanes on the belt of the removal mechanism initially, may then be merged into one lane by means of a, preferably adjustable, guide mechanism of the merging device. The guide mechanism may be formed in the shape of a lateral guide running diagonally to the removal direction across the belt of the removal mechanism and diverting the containers into a lane. The containers may then be packaged by means of a packaging unit. A clock frequency of the clocking mechanism and/or a conveying speed of the removal mechanism may be advantageously adapted to a working speed of the packaging unit in particular. The packaging unit may be a tube bagging machine. By providing a merging device, only one tube bagging machine is required. If a merging device is dispensed with, the packaging unit may comprise a number of packaging devices corresponding to the number of turning devices, for example multiple tube bagging machines.

The system according to the invention for portioned filling of flat products, in particular of potato chips or the like, comprises a product feed unit for feeding the products, a container feed unit for feeding a, preferably bowl-shaped, open container for receiving the products, a portioning unit for portioned transfer of the fed products into the fed container and a turning unit according to the invention. The product feed unit or the container feed unit may feed the products or containers to the portioning unit, which may portion the fed products and, in particular, transfer them into the containers by covering the portions with the containers. Subsequently, the containers covering the portions may be conveyed to the turning unit by means of a conveying mechanism of at least one portioning device of the portioning unit, in order to be turned there before packaging. The container feed unit may have a magazine for storing containers, which may be filled manually. The product feed unit, the container feed unit and the portioning unit may be formed modularly, as may also the turning unit. In particular, the portioning unit may, for example, comprise a plurality of portioning devices corresponding to the plurality of turning devices of the turning unit, each of which may have a conveying mechanism for conveying the containers covering the portions to the turning devices of the turning unit. Further, the system may comprise an operating unit by means of which an operator may operate the system. Further, the system may comprise a control unit, which may control the product feed unit, the container feed unit, the portioning unit and the turning unit in accordance with control commands entered by the operator by means of the control unit.

In one embodiment of the system, the system may comprise a packaging unit for packaging the container with the portion of flat products received in the container. The packaging unit may be a horizontal packing machine. In particular, the packaging unit may be a tube bagging machine. In particular, the container may be packaged in a tube bag.

In the method according to the invention for turning a, preferably bowl-shaped, open container by means of at least one turning device of a turning unit, a portion of flat products, in particular potato chips or the like, is received in the container, wherein the container is turned by being transferred from a first orientation of the container, in which an opening of the container is oriented in a first direction, to a second orientation of the container, in which the opening is oriented in a second direction, by a rotation of the container about an axis of the container. Reference is made to the description of the advantages of the turning unit according to the invention with regard to the advantageous effects of the method according to the invention.

Further advantageous embodiments of the method result from the descriptions of features of the subclaims referring back to apparatus claim 1.

In the method according to the invention for portioned filling of flat products, in particular of potato chips or the like, by means of a system, a portion of the flat products is provided by means of a portioning unit of the system, and to transfer the portions into the container, the portion is covered with a preferably bowl-shaped, open container, with an opening of the container oriented vertically downwards, thus defining a first orientation of the container, wherein the container with the products received in the container is turned by being transferred from a first orientation, in which the opening is oriented vertically downwards, to a second orientation of the container, in which the opening is oriented vertically upwards and/or a bottom of the container is oriented vertically downwards, by means of at least one turning device of a turning unit of the system by a rotation of the container about an axis of the container. Reference is made to the description of the advantages of the turning unit according to the invention with regard to the advantageous effects of the method according to the invention.

Advantageously, the container may be conveyed from the portioning unit to the turning unit in one conveying direction. The portioning unit may have at least one portioning device with a conveying mechanism for this purpose. Alternatively, the turning device may have the conveying mechanism. The container may then be conveyed to the turning unit while in the first orientation and turned there from the first orientation to the second orientation.

Advantageously, the container may be rotated about an axis of the container that runs parallel to the conveying direction during turning.

Advantageously, the container with the portion of flat products received in the container may be packaged after turning by means of a packaging unit of the system, preferably in a tube bag. The container with the portion of flat products received in the container may be packaged in the second orientation.

Further advantageous embodiments of the method result from the descriptions of features of the subclaims referring back to apparatus claim 1.

Preferred embodiments of the inventions are explained in more detail with reference to the accompanying drawings in the following.

### BRIEF DESCRIPTION OF THE DRAWINGS

FIG. 1 a perspective view of a system for portioned filling of flat products from one side;

FIG. 2 a partial perspective view of a turning unit of the system from the front;

FIG. 3 a front perspective view of the turning unit;

FIG. 4 a partial perspective view of the turning unit from above;

FIG. 5 a partial perspective view of the turning unit from the rear;

FIG. 6 a rear perspective view of a turning device of the turning unit before a container is turned;

FIG. 7 a rear perspective view of the turning device after the container has been turned;

FIG. 8 a partial perspective view of the turning unit from above, in particular of a merging device of the turning unit;

FIG. 9 a top view of the merging device;

FIG. 10 a partial view of a system for portioned filling of flat products in another embodiment from one side;

FIG. 11 a partial perspective view of the system from the rear, in particular of a turning unit of the system;

FIG. 12 a partial perspective view of the system from the front, in particular of the turning unit.

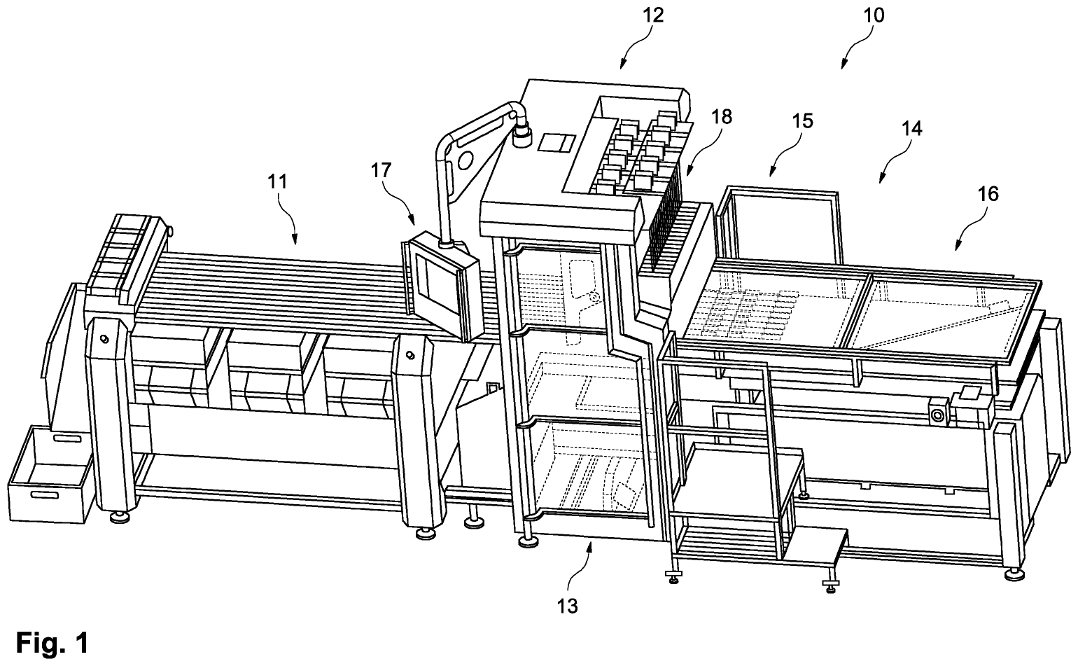

FIG. 1 shows a system 10 for portioned filling of flat products (not shown), in particular of potato chips or the like, in a first embodiment, wherein the system 10 comprises a product feed unit 11 for feeding the products, a container feed unit 12 for feeding bowl-shaped, open containers (not shown) for receiving the products, a portioning unit 13 for portioned transfer of the fed products into the fed containers and a turning unit 14 for turning the containers. The turning unit 14 comprises a plurality of similar turning devices 15 arranged parallel and next to each other and a merging device 16, which is disposed downstream of the turning devices 15 and which is set up to merge the containers turned by means of the turning devices 15 into one lane in a clocked manner. Further, the system 10 comprises an operating unit 17 by means of which an operator may operate the system 10. The system 10 may comprise a control unit, which may control the product feed unit 11, the container feed unit 12, the portioning unit 13 and the turning unit 14 in accordance with control commands entered by the operator by means of the control unit 17. Further, the container feed unit 12 comprises a magazine 18 for storing the containers, which may be filled manually.

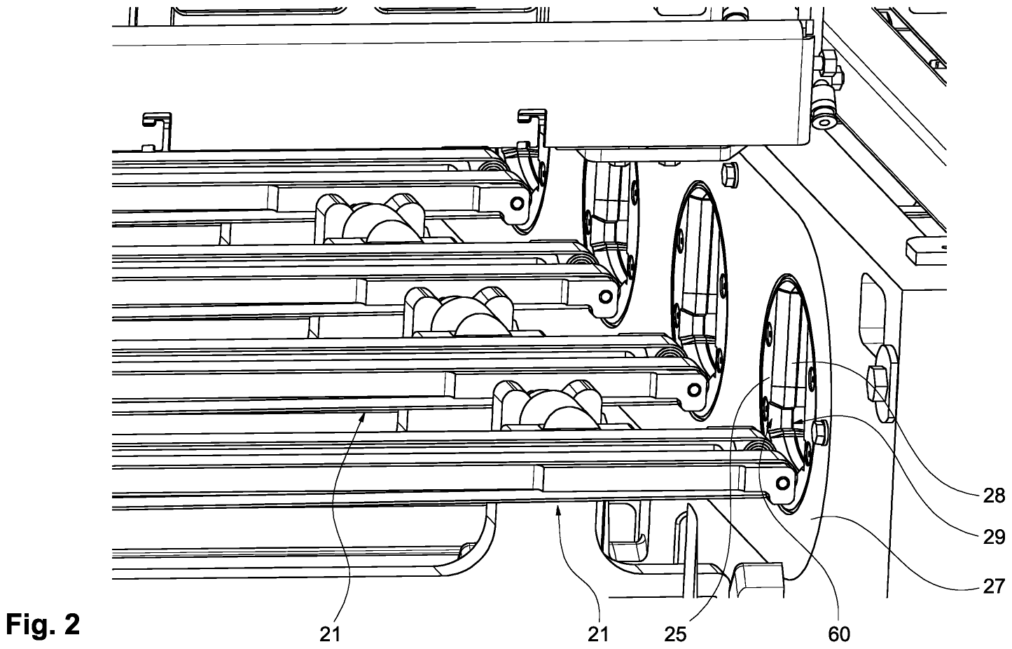

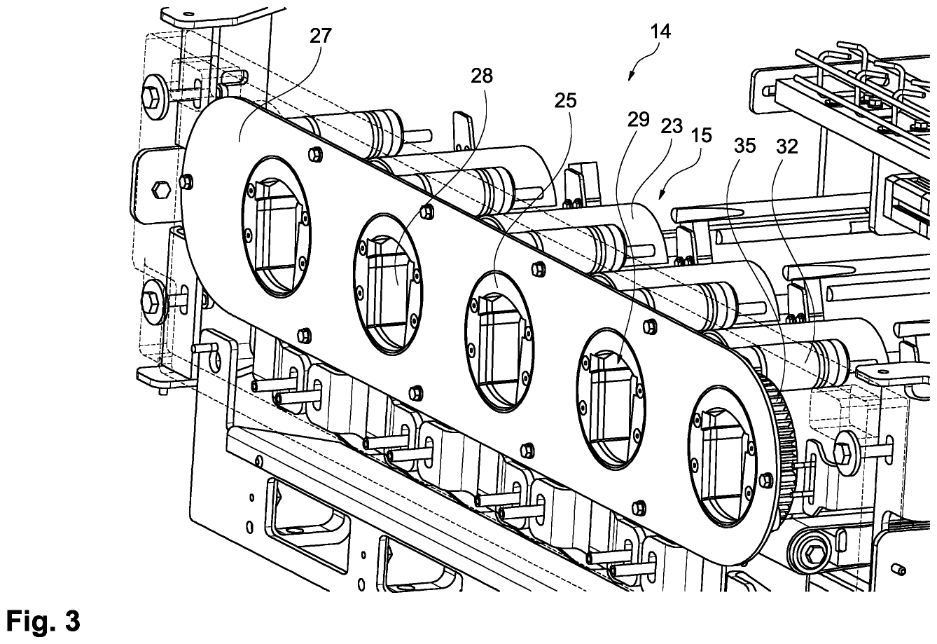

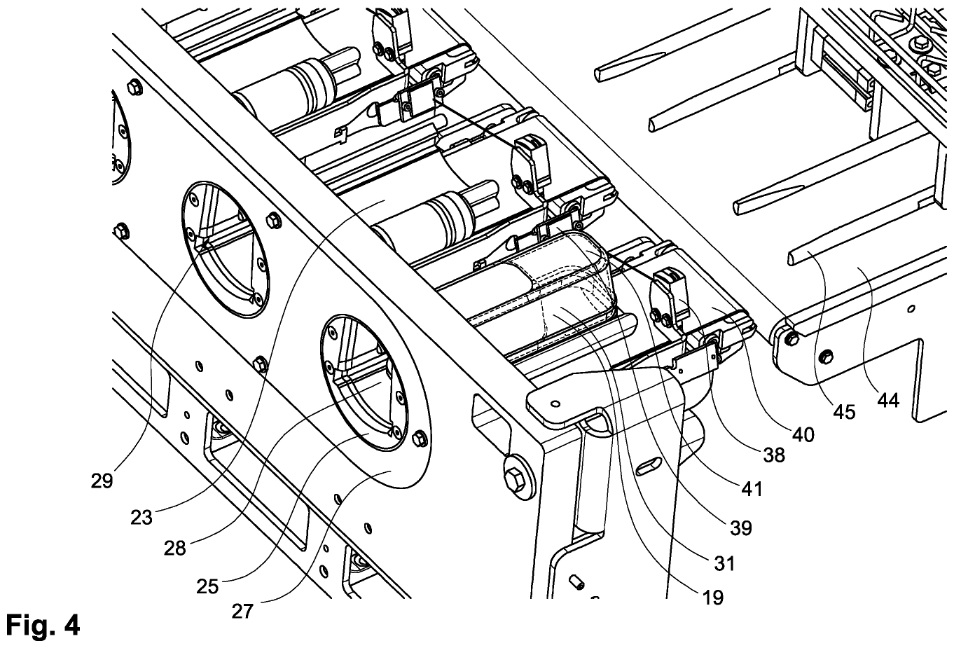

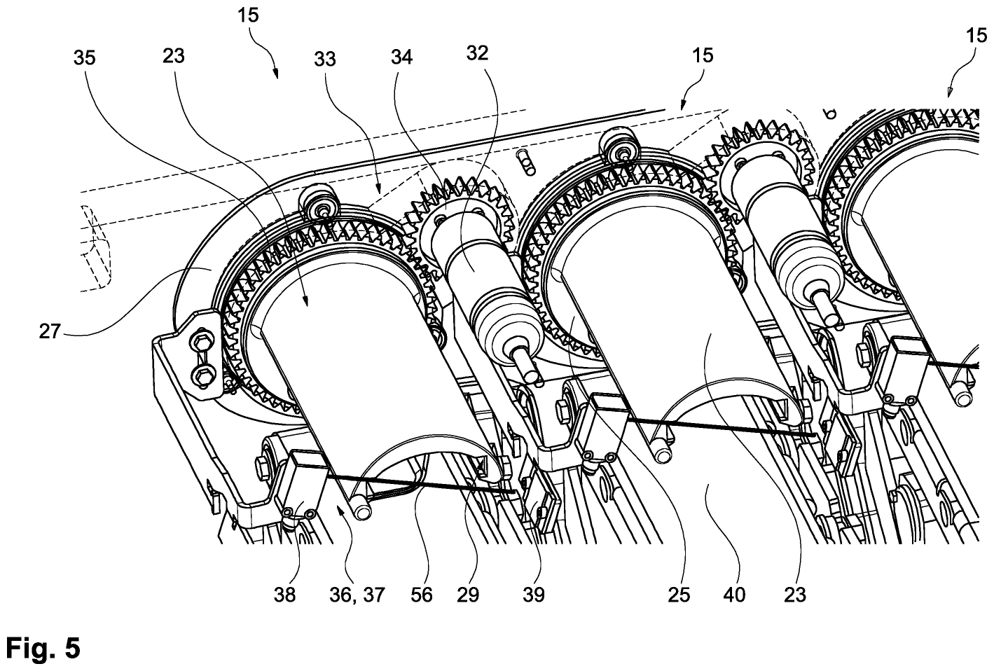

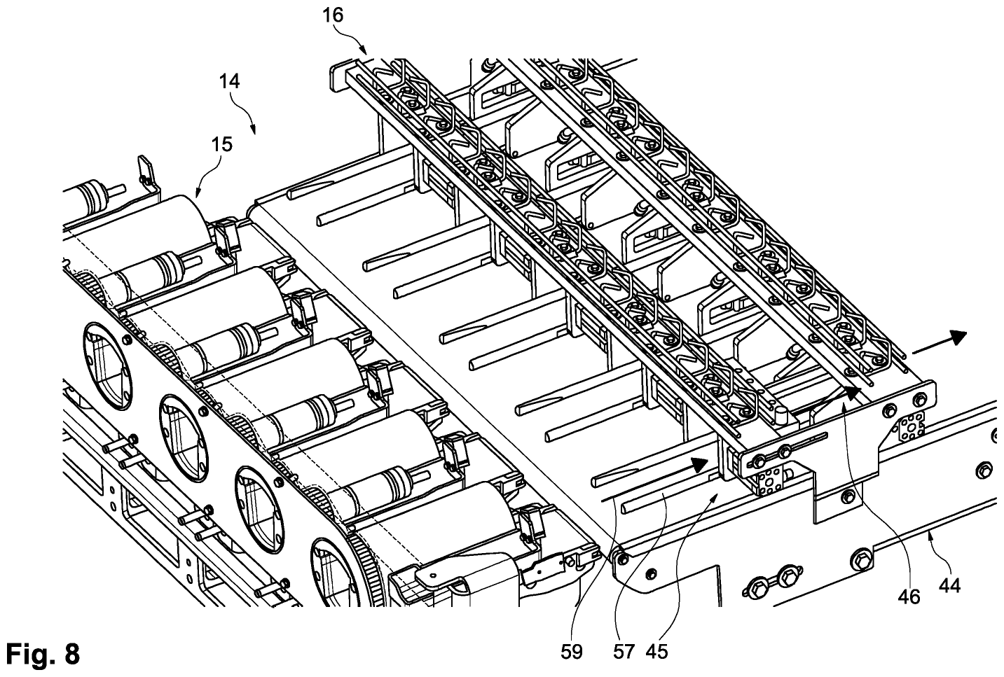

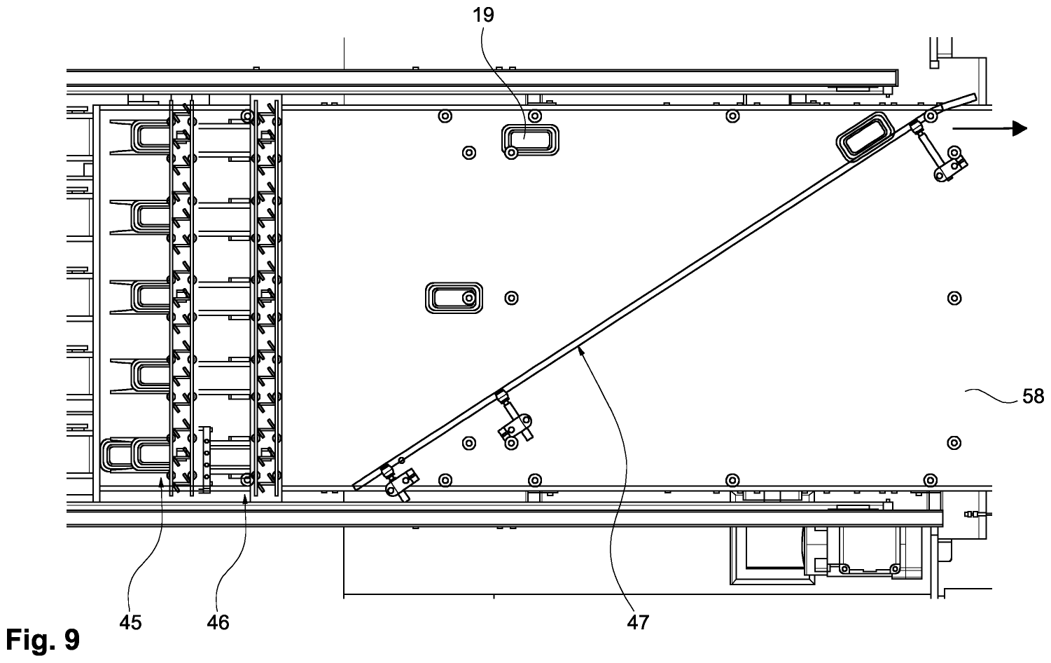

A synopsis of FIGS. 2 to 9 shows various representations of the turning unit 14 and its components with the components partially hidden, depending on the figure. In the following, identical reference symbols are used for structurally identical or functionally identical components or component parts. Furthermore, against the background of the similarity of the turning devices 15 in particular, essentially only one component or only one of its components each is provided with a corresponding reference sign.

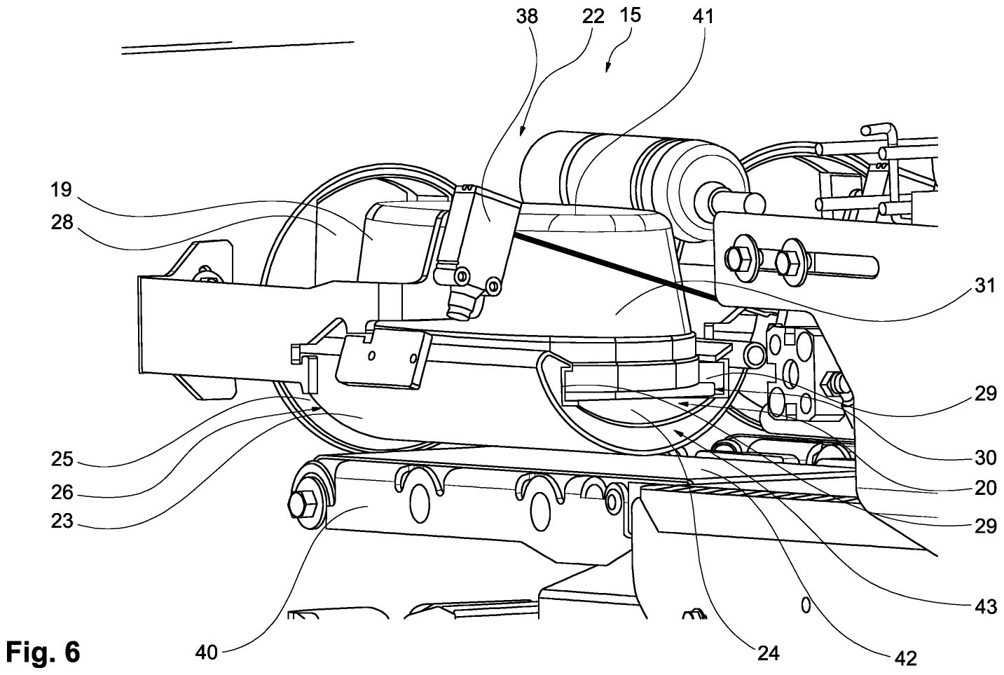

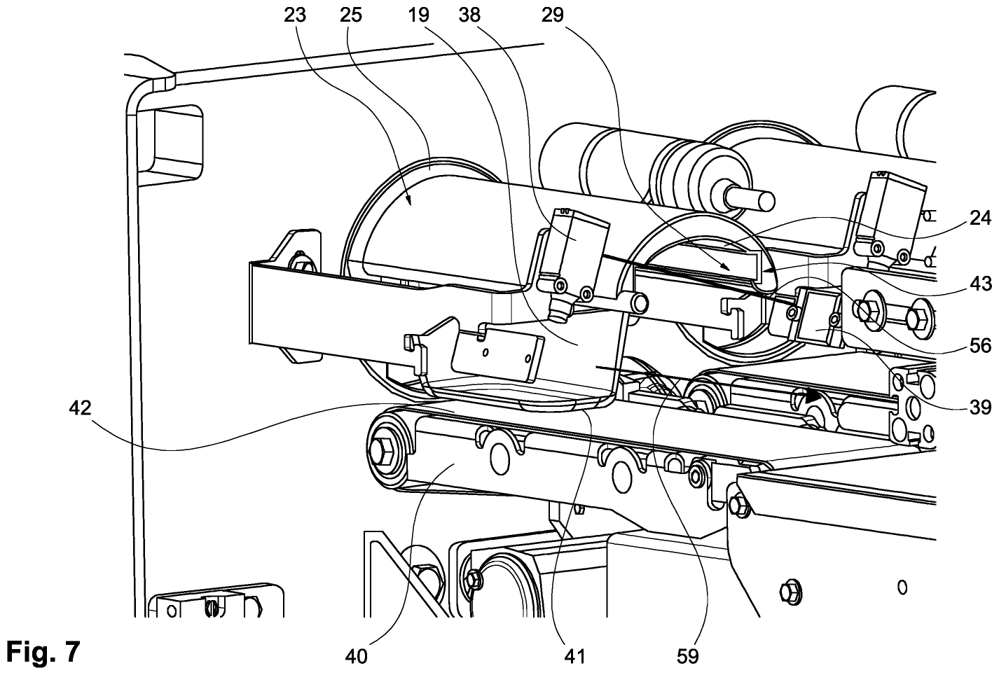

The turning unit 14 comprises the plurality of five similar turning devices 15 that are disposed parallel and next to each other in the present case, wherein each turning device 15 is set up, as shown in FIGS. 6 and 7 in particular, to turn a bowl-shaped open container 19 with a portion of flat products (not shown), in particular of potato chips or the like, received in the container 19 by transferring it from a first orientation of the container 19, in which an opening 20 of the container 19 is oriented vertically downwards (FIG. 6), to a second orientation of the container 19, in which the opening 20 is oriented vertically upwards (FIG. 7), by a rotation of the container 19 about a longitudinal axis (not shown) of the container 19. A provided portion of the flat products is covered with the container 19 with the opening 20 positioned vertically downwards by means of the portioning unit 13 for transferring the portion of flat products into the container 19, wherein the container 19 with the flat products received in the container 19 is conveyed to the turning device 15 by means of a conveying mechanism 21 of at least one portioning device (not shown) of the portioning unit 13 at the opening 20 oriented vertically downwards.

As can be learned from FIG. 2, a plurality of conveying mechanisms 21 disposed parallel and next to each other is provided, which may convey the containers 19 covering corresponding portions of flat products to the plurality of turning devices 15.

Each turning device 15 has a turning mechanism 22 to which the container 19 may be removably connectable, wherein the turning mechanism 22 is rotatable to perform the rotation of the container 19 and is rotated from a first orientation of the turning mechanism 22 to a second orientation of the turning mechanism 22. The turning mechanism 22 has a first section 23, which is formed in the form of a segment of a hollow cylinder and which may be rotated about a longitudinal axis (not shown) of the hollow cylinder, wherein the container 19 is removably connectable to an inside 24 of the first section 23. Further, the turning mechanism 22 has a second section 25, which is formed in the form of a circle or disk and which is disposed rotationally fixed at an axial end 26 of the first section 23 in such a way that a center of the circle (not shown) lies at least approximately on the longitudinal axis of the hollow cylinder, wherein the second section 25 is rotatably mounted in a common cover 27 of a housing device (not shown) of the turning unit 14 and has a passage 28, which is formed to guide the container 19 through the passage for removable connection of the container 19 to the first section 23 or for carrying out a rotation and getting to the first section 23. The container 19 may be removably connectable to the inside 24 in such a way that the opening 20 may be completely coverable by the inside 24 by an orientation of the opening 20 with the inside 24 in order to hold the flat products in the container 19 during turning. Further, the turning mechanism 22 has a receiving track 29, which is formed to receive the container 19 at least in sections by encompassing an edge 30 of two opposing side walls 31 of the container 19, said edge delimiting the opening 20, so as to removably connect the container 19 to the turning mechanism 22. The receiving track 29 in the form of two opposing guide grooves 29 extends along the longitudinal axis of the hollow cylinder over the entire length of the first section 23 and up to an end 60 of the passage 28 facing the conveying mechanism 21. Although the conveying mechanism 21 only extends to the end 60, the container 19 may pass through the passage 28 and get to the first section 23 as a result of a conveying movement of the conveying mechanism 21 while the edge 30 is introduced into the receiving track 29. The edge 30 is thus guidable in a longitudinally movable manner and receivable in the receiving track 29.

Further, each turning device 15 has a drive mechanism 32 for driving the turning mechanism 22, which is formed with an electric motor.

Further, each turning device 15 has a transmission mechanism 33 meshing with the drive mechanism 32 and the turning mechanism 22, which is a gear transmission comprising a first gear wheel 34 coupled to the drive mechanism 32 and a second gear wheel 35 meshing with the first gear wheel 34 and coupled to the turning mechanism 22. The second gear wheel 35 is disposed on a disk or circumference (not shown) of the circle and is formed larger than the first gear wheel 34 in terms of a radius.

Furthermore, each turning device 15 has a sensor mechanism 16, comprising a light barrier 37 with a transmitter 38 and a receiver 39, wherein the light barrier 37 is set up to monitor the container 19 leaving the receiving track 29 after the container 19 has been turned. A light beam 56 is formed between the transmitter 38 and the receiver 39.

In addition, each turning device 15 has a conveying mechanism 40 for conveying away the container 19 after the container 19 has been turned, wherein the conveying mechanism 40 is disposed below the turning mechanism 22 or the first section 23 in such a way that a bottom 41 of the container 19 may be brought to mesh with a conveyor means 42 of the conveying mechanism 40 by transferring the container 19 to the second orientation so that the container 19 is removable from the first section 23 as a result of a force effect of the conveying means 42 on the bottom 41 or is performable from the receiving track 29 at another axial end 43 of the first section 23.

After turning, the container 19 is then conveyed with the opening 20 oriented vertically upwards or with the bottom 41 oriented vertically downwards, which then contacts the conveying means 42, to the merging device 16, where it gets on a removal mechanism 44 of the merging device 16. The containers 19 turned by the plurality of turning devices 15 disposed parallel and next to each other may then be oriented and singled or dispensed in a clocked manner by means of an orientation mechanism 45 of the merging device 16 and a clocking mechanism 46 of the merging device 16, which are disposed on the removal mechanism 44, wherein the containers 19 are subsequently merged from initially five parallel lanes into one lane by means of a guide mechanism 47 of the merging device 16. The orientation mechanism 45 is formed in the form of a lateral guide 57 running along both sides of the container 19 in a removal direction 59. Further, the guide mechanism 47 is formed in the form of a lateral guide 47 running diagonally to the removal direction 59 over a belt 58 of the removal mechanism 44 and diverting the containers 19 into one lane. Subsequently, while in the second orientation, the containers 19 with the products received in the containers 19 may be packaged in tube bags, for example, by means of a packaging unit (not shown), which may be a tube bagging machine.

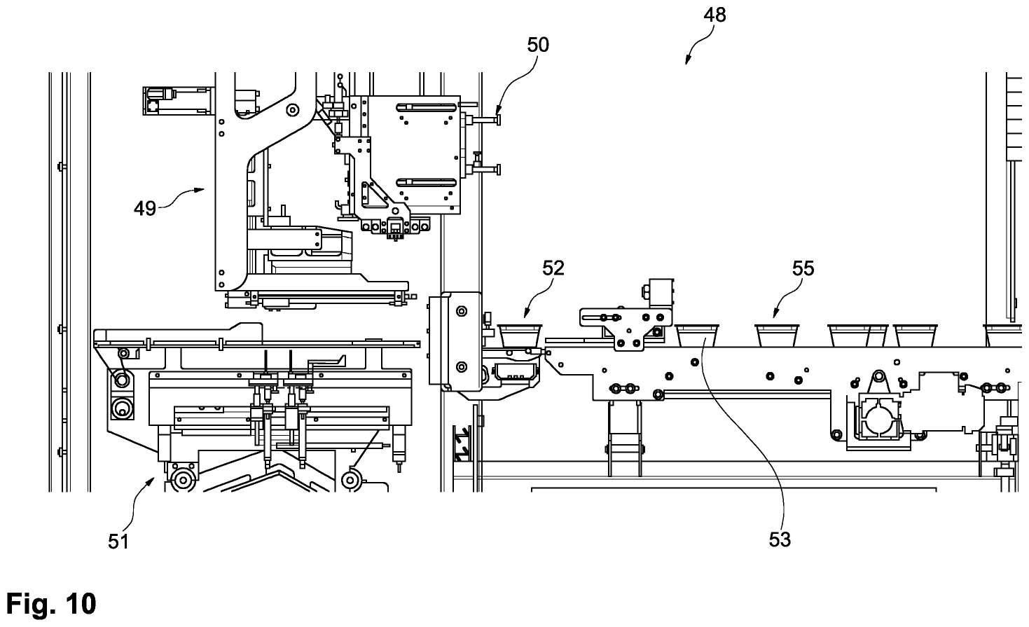

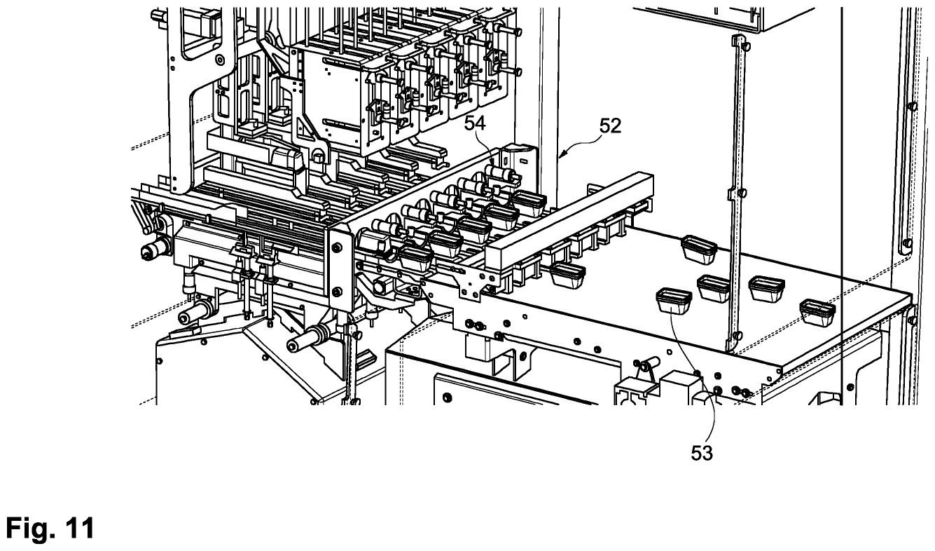

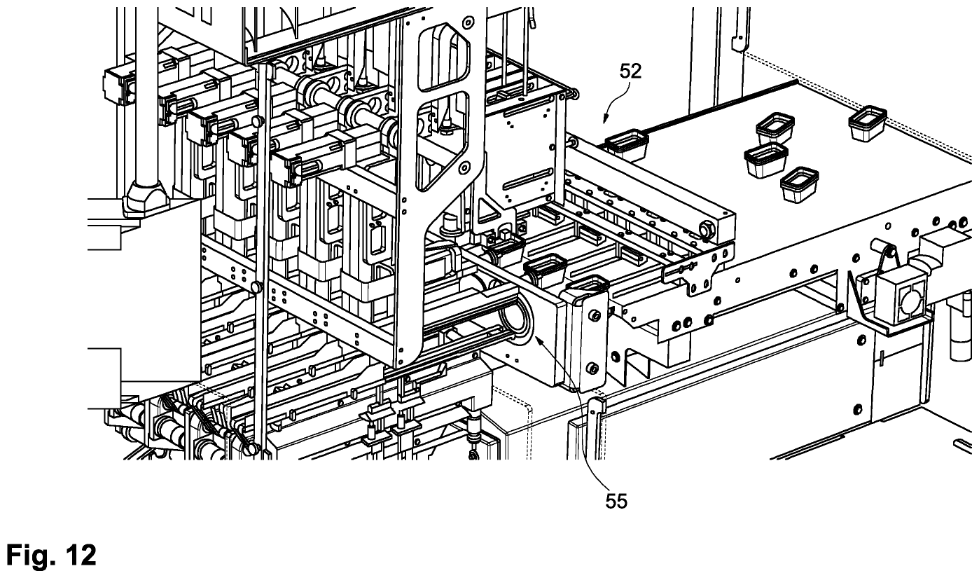

A synopsis of FIGS. 10 to 12 shows a system 48 for portioned filling of flat products (not shown), in particular of potato chips or the like, in another embodiment. The system 48 comprises a product feed unit (not shown), a container feed unit 49 with a magazine 50, a portioning unit 51 and a turning unit 52 for turning containers 53, wherein the turning unit 52 has a plurality of turning devices 54 disposed parallel and next to each other and a merging device 55.

1. A turning unit (14, 52) for turning an, open container (19, 53) with a portion of flat products received in the container, the turning unit (14, 52) comprising at least one turning device (15, 54), which is set up to turn the container by transferring the container from a first orientation of the container, in which an opening (20) of the container is oriented in a first direction, to a second orientation of the container, in which the opening is oriented in a second direction, by a rotation of the container about an axis of the container.

2. The turning unit according to claim 1, wherein, in the first orientation, the opening (20) is oriented vertically downwards and, in the second orientation, the opening is oriented vertically upwards or a bottom (41) of the container (19, 53) is oriented vertically downwards.

3. The turning unit according to claim 1, wherein the turning device (15, 54) is formed in such a way that the container (19, 53) is turnable while the products remain in the container.

4. The turning unit according to claim 1, wherein the turning device (15, 54) has a turning mechanism (22) to which the container (19, 53) may be removably connected, the turning mechanism being formed to be rotatable for the rotation of the container to be performed.

5. The turning unit according to claim 4, wherein the turning mechanism (22) has a first section (23), which is formed in the shape of a segment of a cylinder and which may be rotated about a longitudinal axis of the cylinder, the container (19, 53) being removably connectable to an inside (24) of the first section.

6. The turning unit according to claim 5, wherein the turning mechanism (22) has a second section (25), which is formed in the shape of a circle and which is disposed in a rotationally fixed manner at an axial end (26) of the first section (23) in such a way that a center of the circle lies at least approximately on the longitudinal axis of the cylinder, the second section having a passage (28), which is formed to guide the container (19, 53) through it.

7. The turning unit according to claim 5, wherein the container (19, 53) is removably connectable to the inside (24) in such a way that the opening (20) is at least partially coverable by the inside by orienting the opening towards the inside.

8. The turning unit according to claim 4, wherein the turning mechanism (22) has a receptacle, which is formed to receive the container (19, 53) at least in sections, said edge delimiting the opening (20), so as to removably connect the container to the turning mechanism.

9. The turning unit according to claim 8, wherein the receptacle is formed as a receiving track, (29) in which the edge (30) is receivable and guidable in a longitudinally movable manner.

10. The turning unit according to claim 4, wherein the turning device (15, 54) has a drive mechanism (32) for driving the turning mechanism (22).

11. The turning unit according to claim 10, wherein the turning device (15, 54) has a transmission mechanism (33) meshing with the drive mechanism (32) and the turning mechanism (22).

12. The turning unit according to claim 11, wherein the transmission mechanism (33) is a gear transmission having a first gear wheel (34) coupled to the drive mechanism (32) and a second gear wheel (35) coupled to the turning mechanism (22) and meshing with the first gear wheel.

13. The turning unit according to claim 4, wherein the turning device (15, 54) has a sensor mechanism (36) set up to monitor a removal of the container from the turning mechanism (22) after the container (19, 53) has been turned.

14. The turning unit according to claim 4, wherein the turning device (15, 54) has a conveying mechanism (40) for conveying away the container (19, 53) after turning.

15. The turning unit according to claim 14, wherein the conveying mechanism (40) is disposed adjacent to the turning mechanism (22) in such a way that a bottom (41) of the container (19, 53) can be brought to mesh with a conveying means (42) of the conveying mechanism by transferring the container to the second orientation, so that the container is removable from the turning mechanism by a force effect of the conveying means on the bottom.

16. The turning unit according to claim 1, wherein the turning unit (14, 52) comprises a plurality of turning devices (15, 54) disposed parallel and next to each other.

17. The turning unit according to claim 16, wherein the turning unit (14, 52) has a merging device (16, 55), which is disposed downstream of the turning devices (15, 54) and which is set up to merge containers (19, 53) turned by the turning devices into one lane.

18. A system (10, 48) for portioned filling of flat products, the system (10, 48) comprising a product feed unit (11) for feeding the products, a container feed unit (12, 49) for feeding an open container (19, 53) for receiving the products, a portioning unit (13, 51) for portioned transfer of the fed products into the fed container, and a turning unit (14, 52) according to claim 1.

19. The system according to claim 18, wherein the system (10, 48) comprises a packaging unit for packaging the container (19, 53) with the portion of the flat products received in the container.

20. A method for turning an open container (19, 53) by at least one turning device (15, 54) of a turning unit (14, 52), a portion of flat products being received in the container, the container being turned by being transferred from a first orientation of the container, in which an opening (20) of the container is oriented in a first direction, to a second orientation of the container, in which the opening is oriented in a second direction, by a rotation of the container about an axis of the container.

21. A method for portioned filling of flat products by a system (10, 48), wherein a portion of the flat products is provided by means of a portioning unit (13, 51) of the system, and to transfer the portion into a container, the portion is covered with an, open container (19, 53), with an opening (20) of the container oriented vertically downwards, thus defining a first orientation of the container, the container with the products received in the container being turned by being transferred from the first orientation, in which the opening is oriented vertically downwards, to a second orientation of the container, in which the opening is oriented vertically upwards [[and/]] or a bottom (41) of the container is oriented vertically downwards, by a rotation of the container about an axis of the container by at least one turning device (15, 54) of a turning unit (14, 52) of the system.

22. The method according to claim 21, wherein the container (19, 53) is conveyed in a conveying direction from the portioning unit (13, 51) to the turning unit (14, 52).

23. The method according to claim 22, wherein the container (19, 53) is rotated about an axis of the container running parallel to the conveying direction during turning.

24. The method according to claim 21, wherein the container (19, 53) with the portion of flat products received in the container is packaged after turning by means of a packaging unit of the system (10, 48).
